(19) United States
(12) Patent Application Publication
(10) Pub. No.: US 2007/0189832 A1
(43) Pub. Date: Aug. 16, 2007

(54) Control button assembly for mechanical pen

(75) Inventor: Chin-chieh Yeh, Taipei Hsien (TW)

Correspondence Address: BRUCE H. TROXELL, SUITE 1404, 5205 LEESBURG PIKE, FALLS CHURCH, VA, 22041, US

(73) Assignee: Ta Hsing Electric Wire & Cable Co., Ltd.

(21) Appl. No.: 11/350,815

(22) Filed: Feb. 10, 2006

(51) Int. Cl. B43K 27/00

(52) U.S. Cl. 401/32; 401/29

(57) ABSTRACT

A control button assembly mounted in the top side of a mechanical pen and linked to the mechanical mechanism of the mechanical pen is disclosed to include a base member coupled to the mechanical mechanism of the mechanical pen, a cap capped on the base member for pressing by the user to drive the mechanical mechanism to move a writing tip in and out of the bottom side of the mechanical pen, a tip member threaded onto the base member inside the cap and having two longitudinal side rails respectively coupled to respective longitudinal sliding grooves inside the cap and usable as a touch pen and movable in and out of the cap upon rotary motion of the cap.

### BACKGROUND OF THE INVENTION

1. Field of the Invention

The present invention relates to a mechanical pen and more particularly, to a control button assembly for use in a mechanical pen that controls movement of the writing tip of the mechanism pen and has a retractable tip member for use as a touch pen.

2. Description of the Related Art

A mechanical ballpoint pen or pencil has a control button provided at the top side for pressing by the user to move the writing tip (lead) in and out of the bottom side of the penholder. This control button is specifically provided for controlling the movement of the writing tip without other purpose.

Further, many electronic devices, such as PDA and etc., provide a touch panel for use with a touch pen for data input. Because a touch pen is a small stick, it may be lost easily. It is a good ideal to incorporate a touch pen into a mechanical pen.

### SUMMARY OF THE INVENTION

The present invention has been accomplished under the circumstances in view. It is the main object of the present invention to provide a control button assembly for use to control movement of a writing tip in and out of a mechanical pen that has a retractable tip member for use as a touch pen.

To achieve this and other objects of the present invention, the control button assembly is mounted in the top side of a mechanical pen and linked to the mechanical mechanism of the mechanical pen, comprising a base member coupled to the mechanical mechanism of the mechanical pen, a cap capped on the base member for pressing by the user to drive the mechanical mechanism to move a writing tip in and out of the bottom side of the mechanical pen, a tip member threaded onto the base member inside the cap and having two longitudinal side rails respectively coupled to respective longitudinal sliding grooves inside the cap and usable as a touch pen and movable in and out of the cap upon rotary motion of the cap.

### BRIEF DESCRIPTION OF THE DRAWINGS

FIG. 1 is perspective view showing a control button assembly used in a mechanical pen according to the present invention.

FIG. 2 is an exploded view in an enlarged scale of FIG. 1.

FIG. 3 is an exploded view of the control button assembly shown in FIG. 2.

FIG. 4 is a front view of the base member for the control button assembly according to the present invention.

FIG. 5 is a side view of FIG. 4.

FIG. 6 is a sectional view taken along line A-A of FIG. 4.

FIG. 7 is a plain view of the cap for the control button assembly according to the present invention.

FIG. 8 is a sectional view taken along line A-A of FIG. 7.

FIG. 9 is a plain view of the tip member for the control button assembly according to the present invention.

FIG. 10 is a sectional view taken along line A-A of FIG. 9.

FIG. 11 is a top view of FIG. 10.

FIG. 12 is a schematic sectional view of the present invention, showing the top tip of the tip member kept inside the cap.

FIG. 13 is another schematic sectional view of the present invention, showing the top tip of the tip member extended out of the round hole of the cap.

### DETAILED DESCRIPTION OF THE PREFERRED EMBODIMENT

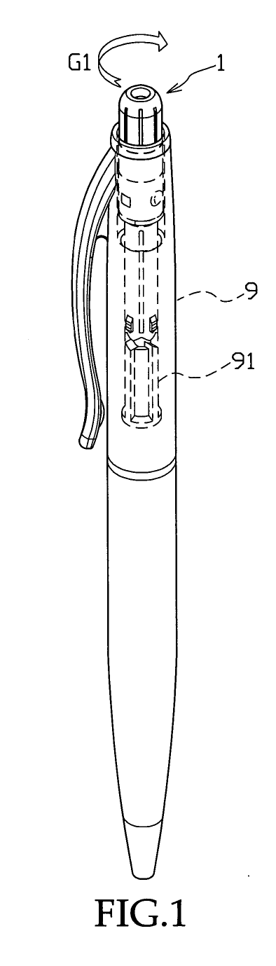

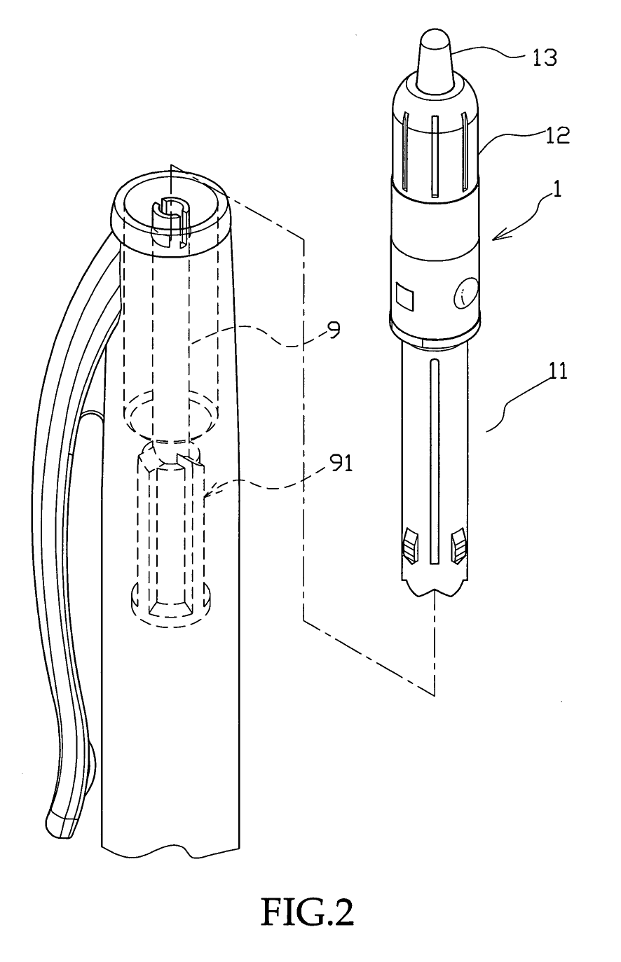

Referring to FIGS. 1 and 2, a control button assembly 1 in accordance with the present invention is shown for installation in the top side of a mechanical pen 9 and linked to the internal mechanical mechanism of the mechanical pen 9 for controlling the movement of the writing tip (not shown) in and out of the bottom side of the mechanism pen 9.

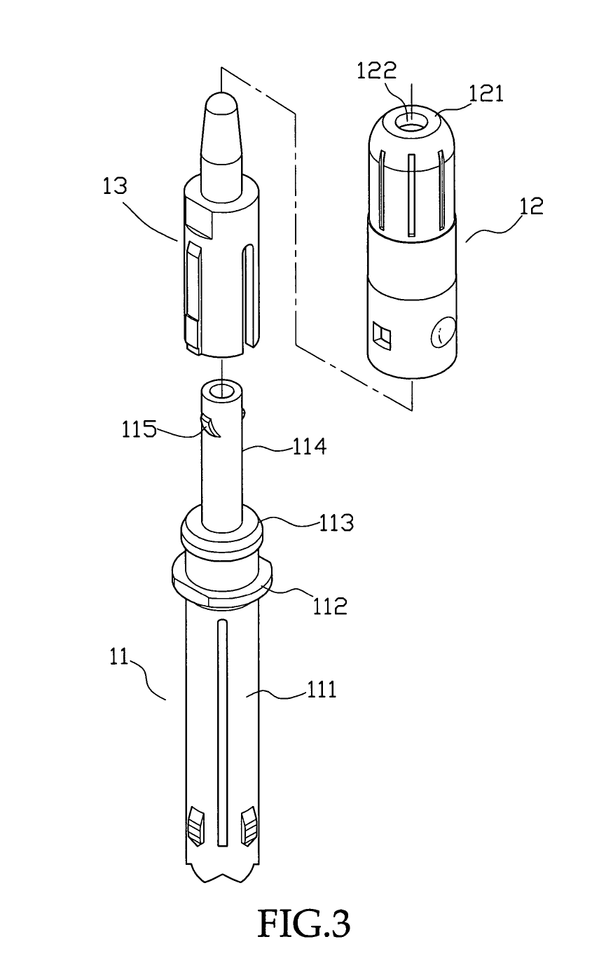

Referring to FIG. 3 and FIGS. 1 and 2 again, the button assembly 1 is comprised of a base member 11, a cap 12, and a tip member 13.

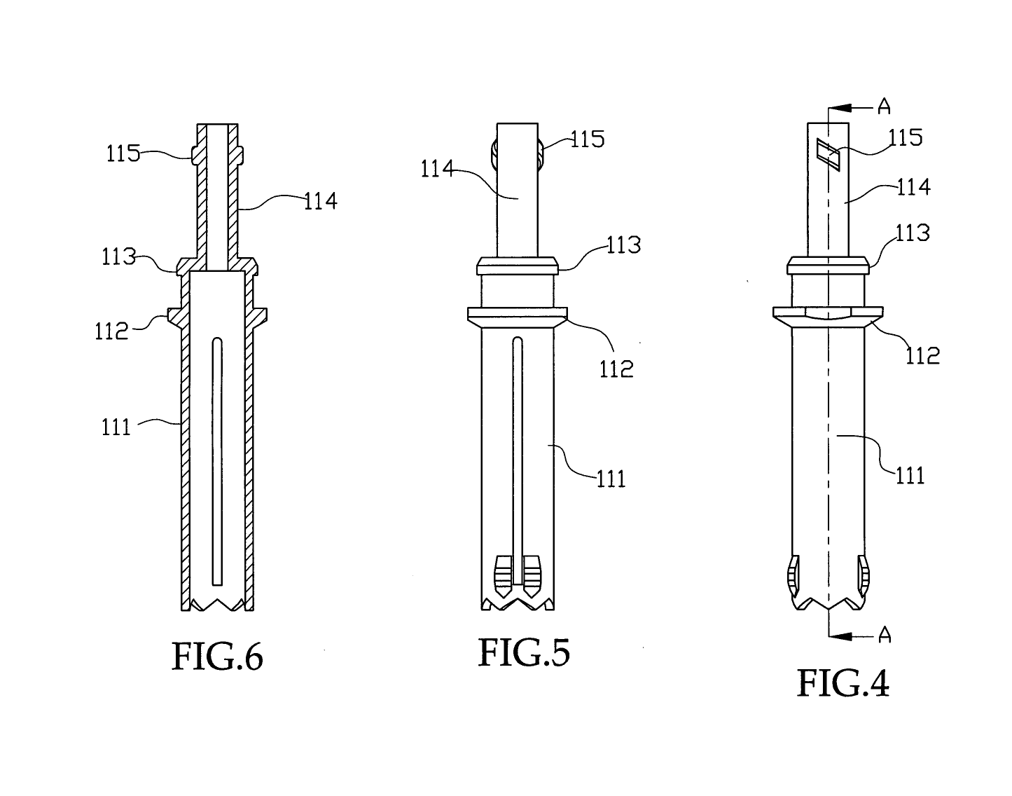

The base member 11 has a tubular bottom connection portion 111 coupled to a key 91 of the internal mechanical mechanism of the mechanical pen 9, a stop flange 112 at the top side of the tubular bottom connection portion 111, a shaft 113 axially extending from one side of the stop flange 112 opposite to the tubular bottom connection portion 111, a top rod 114 axially extending from the top end of the shaft 113 in direction reversed to the tubular bottom connection portion 111, and two protruding portions 115 symmetrically protruded from the periphery of the top rod 114 at two sides (see FIGS. 4˜6). The protruding portions 115 form a male thread structure.

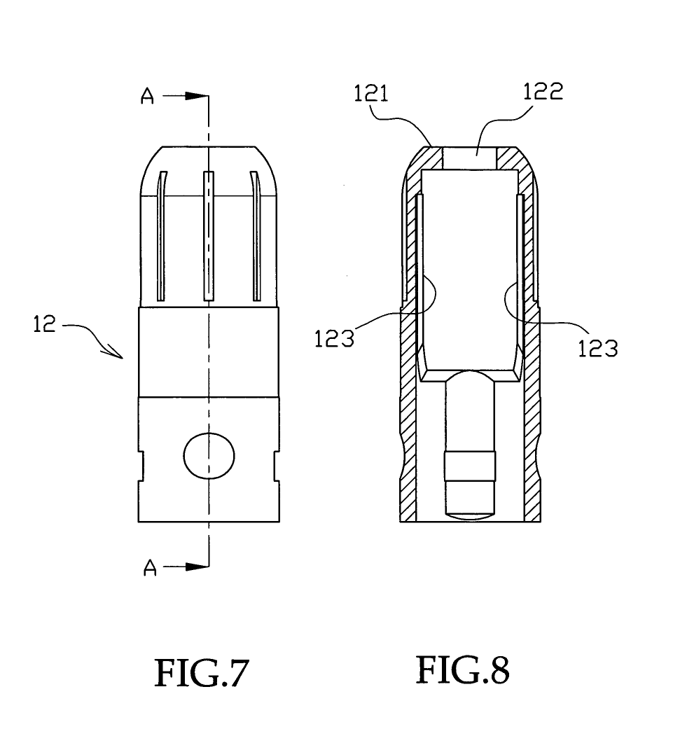

The cap 12 is a barrel capped on the shaft 113 of the base member 11 and rotatably supported on the stop flange 112 of the base member 11 and partially extending out of the top side of the mechanical pen 9, having a round hole 122 cut through the top wall 121 and two longitudinal sliding grooves 123 formed in the inside wall thereof at two sides (see FIGS. 7 and 8).

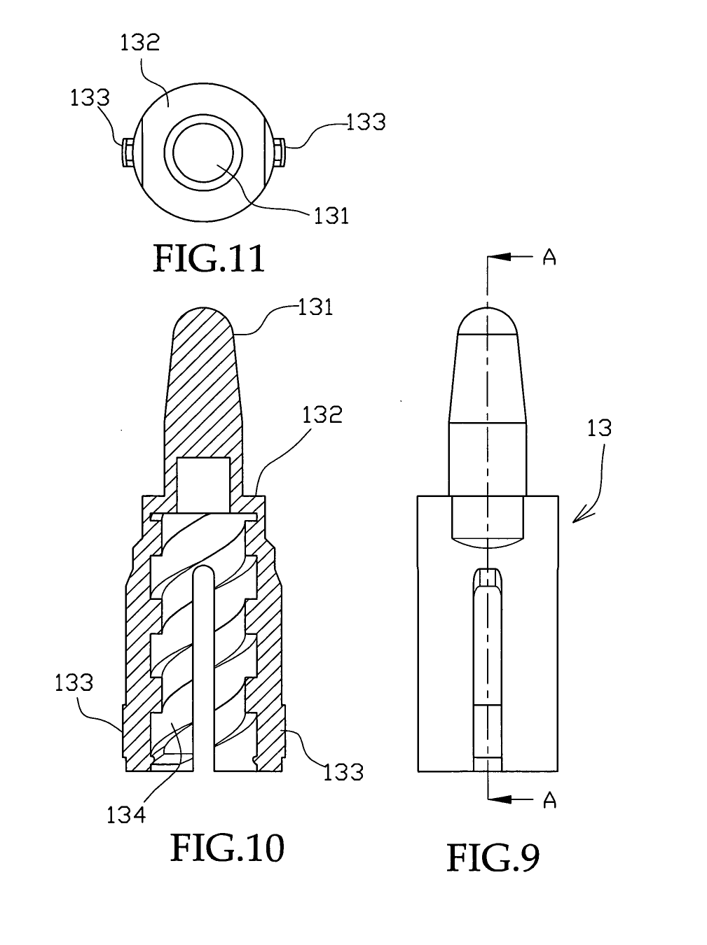

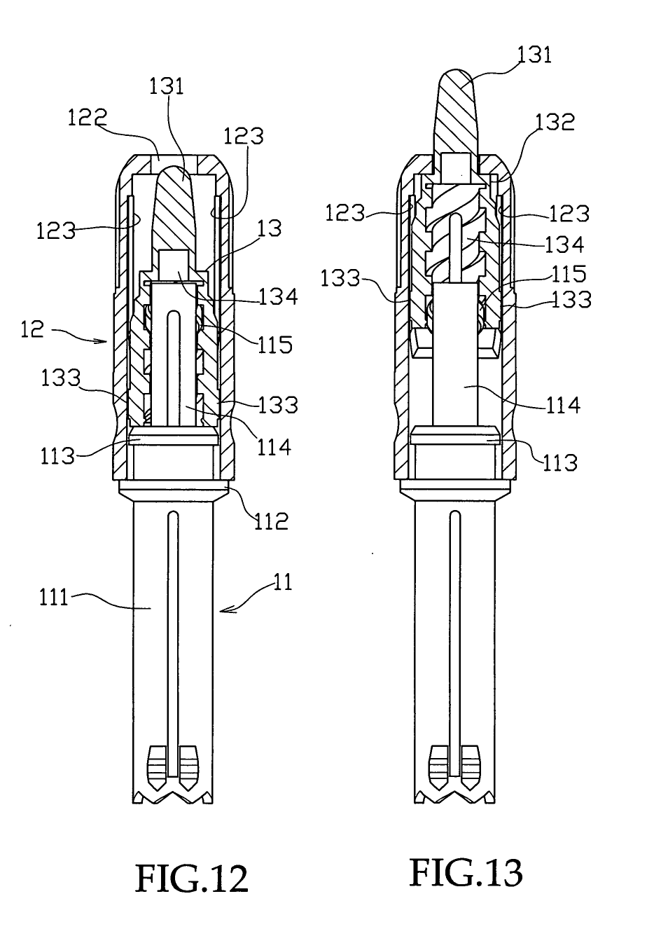

Referring to FIGS. 9˜11 and FIGS. 1˜3 again, the tip member 13 is a hollow, stepped tip capped on the top rod 114 of the base member 11 and axially movable relative to the base member 11, having two longitudinal rails 133 symmetrically disposed at two sides and respectively coupled to the longitudinal sliding grooves 123 inside the cap 12, a shoulder 132, which is disposed on the middle and kept inside the cap 12 and has a diameter greater than the round hole 122 of the cap 12, a top tip portion 131, which extends out of round hole 122 of the cap 12, and a female thread (spiral groove) 134 spirally extending around the inside wall thereof and coupled to the two protruding portions 115 (see FIGS. 12 and 13).

FIG. 12 shows the top tip portion 131 of the tip member 13 received inside the cap 12. When the cap 12 is rotated relative to the mechanical pen 9 at this time (see the arrowhead sign G1 in FIG. 1), the tip member 13 will be forced to move along the longitudinal sliding grooves 123 of the cap 12 and to further extend the top tip portion 131 out of the round hole 122 of the cap 12 and stop the shoulder 132 against the bottom side of the top wall 121 of the cap 12 (see FIG. 13).

In the aforesaid preferred embodiment of the present invention, the control means that controls movement of the tip member 13 in and out of the cap 12 comprises a sliding guide and a driving mechanism. The sliding guide is comprised of the longitudinal sliding grooves 123 and the longitudinal rails 133. The driving mechanism comprises the female thread (spiral groove) 134 that extends spirally around the inside wall of the tip member 13, and the protruding portions (male threads) 115 that are provided at the periphery of the top rod 114 of the base member 11 and coupled to the female thread (spiral groove) 134.

Although a particular embodiment of the invention has been described in detail for purposes of illustration, various modifications and enhancements may be made without departing from the spirit and scope of the invention. Accordingly, the invention is not to be limited except as by the appended claims.

1. A control button assembly mounted in a top side of a mechanical pen and linked to a mechanical mechanism of said mechanical pen, said mechanical mechanism being adapted to move a writing tip in and out of a bottom side of side mechanical pen, the control button assembly comprising:
a base member, said base member having a connecting portion coupled to the mechanical mechanism of said mechanical pen;
a cap capped on said base member for pressing by the user to drive said mechanical mechanism to move said writing tip in and out of the bottom side of said mechanical pen, said cap having a top wall and a round hole cut through said top wall; and
a tip member supported on said base member inside said cap; and
a control means operable to move said tip member in and out of the round hole of said cap;
wherein said control means comprises a driving mechanism adapted to move said tip member longitudinally in and out of the round hole of said cap;
wherein said driving mechanism comprises female threads spirally provided inside said tip member, a shaft fixedly provided at said base member and inserted into said cap to guide rotation of said cap relative to said base, a top rod axially upwardly extending from said shaft and suspending in said tip member, and male threads in the form of a plurality of separate protrusions fixedly provided at the periphery of said top rod and coupled to said female threads.

2. The control button assembly as claimed in claim 1, wherein said control means comprises a sliding guide adapted to guide movement of said tip member longitudinally relative to said cap.

3. The control button assembly as claimed in claim 1, wherein said sliding guide comprises two longitudinal sliding grooves bilaterally disposed inside said cap, and two longitudinal rails bilaterally provided at said tip member and respectively coupled to said longitudinal sliding grooves.

4-5. (canceled)

6. The control button assembly as claimed in claim 1, wherein said connecting portion of said base member has a tubular structure coupled to a key at a top side of said mechanical mechanism of said mechanical pen.
